(19) United States
(12) Patent Application Publication
(10) Pub. No.: US 2026/0288427 A1
(43) Pub. Date: Sep. 24, 2026

(54) METHOD AND SYSTEM FOR AUTOMATED WEBSITE GENERATION

(71) Applicant: HITIT SOFT INC., Seoul (KR)

(72) Inventor: Ju Hyun JUNG, Seoul (KR)

(73) Assignee: HITIT SOFT INC., Seoul (KR)

(21) Appl. No.: 19/085,185

(22) Filed: Mar. 20, 2025

(30) Foreign Application Priority Data
Mar. 19, 2025 (KR) 10-2025-0035208

(51) Int. Cl. G06F 8/35; G06F 8/36

(52) U.S. Cl. CPC G06F 8/35; G06F 8/36

(57) ABSTRACT

An automatic website generation method is provided, the method comprising: acquiring identification information of a reference website; collecting data accessible through the identification information of the reference website, the collected data including data defining a structure or design of the reference website and websites linked to the reference website; determining a type of the reference website based on the collected data; generating structured data based on the collected data; and generating front-end or back-end code of a target website based on at least one of the structured data or the type of the reference website.

### CROSS-REFERENCE TO RELATED APPLICATIONS

The present application claims the benefit of priority to Korean Patent Application No. 10-2025-0035208, filed on Mar. 19, 202, in the Korean Intellectual Property Office. The disclosure of the above-listed application is hereby incorporated by reference herein in its entirety.

### TECHNICAL FIELD

The present disclosure relates to an automatic website generation method and system, and more specifically, to a method and system capable of automatically generating front-end and back-end code of a target website by analyzing the structure and design of a reference website to determine the type of website.

### BACKGROUND ART

Recently, with the advancement of artificial intelligence (AI) and automation technologies, there has been a growing demand for automation in website development. Website development generally includes the processes of planning, design, front-end development, back-end development, and deployment, and various technologies and development tools are used for these processes. In particular, to quickly build customized websites that meet the needs of companies or individual users, template-based website generation tools are being utilized.

Some of the conventional website generation technologies implement a method of converting HTML and CSS data provided by a user into static web pages or applying a specific template as-is to generate a website. However, such approaches are limited in that they simply copy the structure and functions of a website or only allow changes within a limited template. Specifically, in the process of automatically generating a new website based on an existing one, the dynamic elements of the original website (e.g., application programming interface (API) integration, user interface (UI) interactions, database structures, etc.) may not be sufficiently reflected, resulting in a lack of functional similarity.

In addition, many existing technologies do not clearly determine or analyze the type of website and are often based on simple HTML/CSS conversion or manual editing. As a result, it may be difficult to automatically recognize and convert the layout, functions, and data flow of a specific website in an optimized manner.

Accordingly, there is a need for more sophisticated automation technology capable of analyzing the structure and design elements of an existing website to determine the type of website and automatically generate front-end and back-end code based on the result of the analysis. Through such technology, the website development process can be simplified, and customized websites can be rapidly built. Furthermore, the solution can be extended to various platforms such as web applications and mobile applications (e.g., Android, iOS, etc.).

### PRIOR ART DOCUMENTS

### Patent Documents

Registered Patent No. KR 10-2742558 (Registered on Dec. 10, 2024) DISCLOSURE

### Technical Problem

One objective of the present disclosure is to provide an automatic website generation method and system, which collects data defining the structure and design of a reference website, analyzes the data to automatically determine the type of website, and generates front-end and back-end code of a target website based on the result of the determination.

Another objective of the present disclosure is to provide an automatic website generation method and system, which automatically collects dynamically loaded data while navigating a website using a headless browser, and analyzes the structural elements of the website and the relationships between the website and other related websites based on the collected data, thereby performing more precise website type determination.

Another objective of the present disclosure is to provide an automatic website generation method and system, which automatically determines the type of a website or converts the website data into a structured data format by utilizing a fine-tuned large language model (LLM) trained on HTML, CSS, JavaScript, UI elements, metadata, and screen transition flows of websites.

Another objective of the present disclosure is to provide an automatic website generation method and system, which automatically generates a hierarchical information structure of a website, determines the type of the website by analyzing the hierarchical information structure, and thereby offers a solution that is differentiated from a conventional simple HTML copying method.

Another objective of the present disclosure is to provide an automatic website generation method and system, which captures the screen of a reference website, analyzes the UI elements and layout patterns of the captured screen, and thereby improves the accuracy of website type determination.

Another objective of the present disclosure is to provide an automatic website generation method and system, which identifies dynamic elements (e.g., application programming interface (API) integration, user interaction, real-time data processing) by analyzing the structure and functions of a reference website, and automatically generates front-end and back-end code of a target website by reflecting the identified dynamic elements.

Another objective of the present disclosure is to provide an automatic website generation method and system, which, when a reference website includes characteristics of multiple types, automatically classifies the website as a specific type by analyzing the key functions and structural features of the website, and continuously learns to update the criteria for website type determination even as new types of websites emerge.

The objectives of the present disclosure are not limited to those mentioned above, and other objectives not explicitly stated will be clearly understood by those skilled in the art based on the following description.

### Technical Solution

A method for automatically generating a website according to an embodiment of the present disclosure for solving the above-described technical problem may comprise: acquiring identification information of a reference website; collecting data accessible through the identification information of the reference website, the data comprising data defining a structure or design of the reference website and websites linked to the reference website; determining a type of the reference website based on the collected data; generating structured data based on the collected data; and generating front-end or back-end code of a target website based on at least one of the structured data or the type of the reference website.

According to an embodiment, the method may further comprise analyzing the structure and functions of the reference website to identify dynamic elements of the website, wherein the dynamic elements may comprise an application programming interface (API), and generating the front-end or back-end code of the target website by reflecting the identified dynamic elements.

According to an embodiment, the collecting of the data accessible through the identification information of the reference website may comprise: exploring the reference website and websites linked to the reference website using a headless browser; and collecting data defining the structure or design of the reference website based on data dynamically loaded during the exploration.

According to an embodiment, the determining of the type of the reference website or the generating of the structured data based on the collected data may be performed using a large language model (LLM) that has been pre-trained and fine-tuned on HTML, CSS, JavaScript, user interface (UI) elements, metadata, or screen transition flows of websites, wherein the LLM may automatically classify the type of a specific website by analyzing layout, UI elements, and functional attributes of the website, or convert unstructured website data into a structured format.

According to an embodiment, the determining of the type of the reference website may comprise: generating a hierarchical information structure of the reference website using the collected data, wherein the hierarchical information structure comprises tree-structured data; and determining the type of the reference website using the hierarchical information structure.

According to an embodiment, the determining of the type of the reference website may comprise: capturing screens of the reference website and at least one website linked to the reference website; and determining the type of the reference website using images of the captured screens.

According to an embodiment, the determining of the type of the reference website may comprise: when the reference website comprises characteristics of multiple types, determining a single type among the multiple types by analyzing major functions and structural characteristics of the reference website; and updating the criteria for type determination by performing website data learning to improve the accuracy of the type determination.

According to another embodiment of the present disclosure, a system for automatically generating a website for solving the above-described technical problem may comprise a processor and a memory storing instructions, wherein the instructions, when executed by the processor, cause the processor to perform operations of: acquiring identification information of a reference website; collecting data accessible through the identification information of the reference website, the data comprising data defining a structure or design of the reference website and websites linked to the reference website; determining a type of the reference website based on the collected data; generating structured data based on the collected data; and generating front-end or back-end code of a target website based on at least one of the structured data or the type of the reference website.

According to an embodiment, the at least one processor may be further configured to perform operations of: analyzing the structure and functions of the reference website to identify dynamic elements of the website, wherein the dynamic elements may comprise an application programming interface (API); and generating the front-end or back-end code of the target website by reflecting the identified dynamic elements.

According to an embodiment, the operation of collecting data accessible through the identification information of the reference website may comprise: exploring the reference website and websites linked to the reference website using a headless browser; and collecting data defining the structure or design of the reference website based on data dynamically loaded during the exploration.

According to an embodiment, the operation of determining the type of the reference website or generating the structured data based on the collected data may be performed using a large language model (LLM) that has been pre-trained and fine-tuned on HTML, CSS, JavaScript, user interface (UI) elements, metadata, or screen transition flows of websites, wherein the LLM may automatically classify the type of a specific website by analyzing layout, UI elements, and functional attributes of the website, or convert unstructured website data into a structured format.

According to an embodiment, the operation of determining the type of the reference website may comprise: generating a hierarchical information structure of the reference website using the collected data, wherein the hierarchical information structure comprises tree-structured data; and determining the type of the reference website using the hierarchical information structure.

According to an embodiment, the operation of determining the type of the reference website may comprise: capturing screens of the reference website and at least one website linked to the reference website; and determining the type of the reference website using images of the captured screens.

According to an embodiment, the operation of determining the type of the reference website may comprise: when the reference website comprises characteristics of multiple types, determining a single type among the multiple types by analyzing major functions and structural characteristics of the reference website; and updating the criteria for type determination by performing website data learning to improve the accuracy of the type determination.

### BRIEF DESCRIPTION OF DRAWINGS

FIG. 1 is a diagram illustrating the connection relationship between a user terminal and an automatic website generation system according to an embodiment;

FIG. 2 is a diagram schematically illustrating a process of automatically generating a website and an application according to an embodiment;

FIG. 3 is a diagram for explaining a method for acquiring identification information of a reference website according to an embodiment;

FIG. 4 is a diagram for explaining a method for acquiring data defining the structure or design of reference and linked websites according to an embodiment;

FIG. 5 is a diagram for explaining how to perform website type determination and vector data acquisition according to an embodiment;

FIG. 6 is a diagram for explaining a process of generating front-end and back-end code according to an embodiment;

FIG. 7 is a diagram for explaining a process of generating a website, an iOS application, and an Android application according to an embodiment;

FIG. 8 is a diagram for explaining a process of registering a product after website generation according to an embodiment;

FIG. 9 is a flowchart illustrating the overall steps of an automatic website generation method according to an embodiment;

FIG. 10 is a flowchart illustrating additional steps of the automatic website generation method according to an embodiment; and

FIG. 11 is a block diagram illustrating the hardware configuration of a computing device associated with automatic website generation according to an embodiment of the present disclosure.

### MODE FOR INVENTION

Hereinafter, preferred embodiments of the present disclosure will be described in detail with reference to the accompanying drawings. The advantages and features of the present disclosure, and methods of achieving them, will become apparent from the embodiments described below in conjunction with the drawings. However, the present disclosure is not limited to the embodiments described herein and may be implemented in various other forms. The embodiments are provided to make the disclosure complete and to fully convey the scope of the invention or disclosure to those skilled in the art. The present disclosure is defined only by the scope of the claims.

It should be noted that, in the drawings, the same reference numerals are used to denote the same components, even if they appear in different drawings. In describing the present disclosure, detailed descriptions of well-known components or functions may be omitted if it is determined that such descriptions would obscure the essence of the disclosure.

Unless otherwise defined, all terms (including technical and scientific terms) used in this specification have the same meaning as those commonly understood by one of ordinary skill in the art to which this disclosure pertains. Terms defined in generally used dictionaries should be interpreted as having meanings consistent with the relevant technical field and should not be interpreted in an overly idealistic or excessively broad sense unless explicitly defined otherwise.

The terminology used in this specification is intended to describe particular embodiments only and is not intended to limit the scope of the invention or disclosure. As used herein, the singular forms also include the plural forms unless the context clearly dictates otherwise.

Furthermore, in describing the components of the present disclosure, terms such as “first,” “second,” “A,” “B,” “(a),” “(b),” and the like may be used. These terms are merely for distinguishing one component from another and do not imply any limitation on the nature, order, or sequence of the components. When a component is described as being “connected to,” “coupled to,” or “linked to” another component, it should be understood that the component may be directly connected, coupled, or linked to the other component, or one or more other components may be interposed between them.

As used in this specification, the terms “comprises” and/or “comprising” do not exclude the presence of one or more other elements, steps, operations, and/or components in addition to the listed elements, steps, operations, and/or components.

The present disclosure is described mainly with respect to an automatic website generation method, but it is not limited thereto. The technology proposed in the present disclosure analyzes the structure and functions of a website and automatically generates front-end and back-end code based on the result of the analysis, and can thus be applied not only to web applications but also to the automatic generation of iOS and Android applications. For example, a website type determination technique, a structured data conversion method, and a dynamic element analysis technology utilized in the present disclosure can also be applied to user interface (UI)/user experience (UX) design and function implementation of mobile applications, and can be used in the process of automatically generating applications optimized for various platforms.

In the present disclosure, a reference website refers to an existing website to be analyzed during an automatic website generation process, and may be used interchangeably with a “referenced website.” In contrast, a target website may refer to a website automatically generated by an AI reconstruction engine or a cloud-based source code generator based on the analysis result of the reference website.

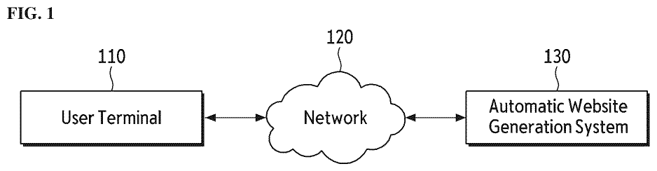

FIG. 1 is a diagram illustrating the connection relationship among a user terminal (110), a network (120), and an automatic website generation system (130) according to an embodiment.

The user terminal (110) may include a device capable of transmitting and receiving data to and from the automatic website generation system (130). For example, the user terminal (110) may include a computer, a tablet, a smartphone, or another device for entering an automatic website generation request, and a user may input a website URL or specific identification information through the device. In addition, the user terminal (110) may receive code, a preview screen, or configurable options for a generated website from the automatic website generation system (130).

The network (120) may include a communication network that enables data transmission and reception between the user terminal (110) and the automatic website generation system (130). The network (120) may include wired and wireless communication technologies such as the Internet, a local area network (LAN), a wide area network (WAN), a mobile communication network (e.g., 4G, 5G, etc.), or Wi-Fi. Further, the network (120) may not only function as a simple connection path but also perform functions such as minimizing data transmission delays, encryption, packet segmentation, and transmission optimization. For example, the network (120) may relay data via a specific application programming interface (API) gateway or proxy server and support reliable delivery of requests from the user terminal (110) to the automatic website generation system (130).

The automatic website generation system (130) may perform the function of automatically generating a website based on information received from the user terminal (110). Specifically, the automatic website generation system (130) may analyze the URL of an input website, collect data defining the structure and design of the input website, and determine the type of the input website based on the collected data. The automatic website generation system (130) may also analyze the structure and dynamic elements of the input website, convert the analyzed data into structured data, and automatically generate front-end and back-end code of a target website based on the structured data.

In one embodiment, a website generated by the automatic website generation system (130) may be provided to the user terminal (110), and the user may check or modify the generated website through additional settings. For example, the user may be provided with options to select a specific website type, adjust UI components, or modify parts of the automatically generated code.

In this manner, the user terminal (110), the network (120), and the automatic website generation system (130) may work in cooperation to perform the function of automatically generating a website based on the user's input and providing the generated website to the user.

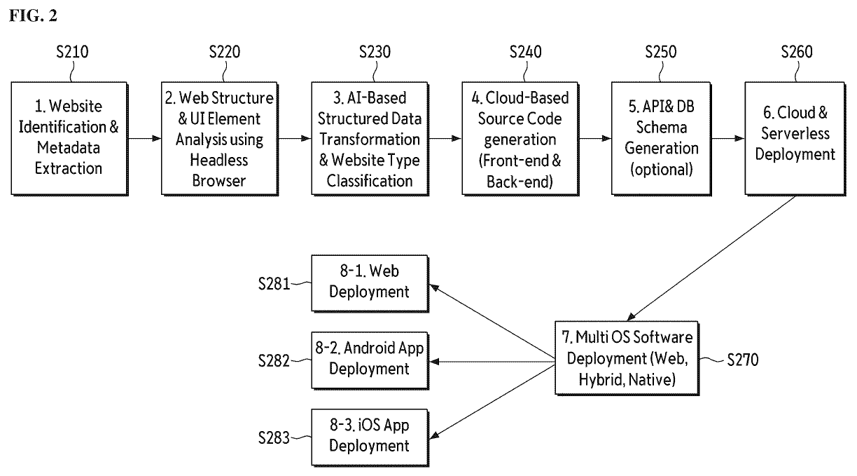

FIG. 2 is a diagram schematically illustrating a process of automatically generating a website and an application according to an embodiment.

In one embodiment, a plurality of steps may be performed to automatically generate a website and an application based on user input. Specifically, referring to FIG. 2, the plurality of steps may include website identification and metadata extraction (S210), analysis of a web structure and UI elements (S220), AI-based structured data conversion and website type determination (S230), cloud-based source code generation (S240), API and database schema generation (S250), cloud and serverless deployment (S260), and multi-OS software deployment (S270). In addition, the content of the present disclosure may be applied not only to website generation but also to generation and deployment of Android and iOS applications (S281 through S283).

In step S210, after acquiring the URL or other identification information of a website, HTML, CSS, JavaScript, UI elements, and metadata of the website may be extracted. In one embodiment, step S210 may include receiving the URL of a specific website from a user.

In step S220, a process of analyzing the structure and UI elements of the website using a headless browser may be performed. In this process, HTML, CSS, and JavaScript data of the website may be collected, and UI elements such as buttons, input fields, and links may be identified to understand a screen transition flow. In addition, when a new page or an external website is accessed by clicking a specific button, the corresponding page or website may also be automatically navigated and analyzed. The headless browser can identify all HTML elements of a web page without directly rendering the screen, thereby effectively analyzing the overall operation and structure of the website.

In step S230, a process of converting the collected data into structured data using an AI model and automatically classifying the website may be performed. According to one embodiment, the structured data may be vector data including JSON. Further, by using a large language model (LLM) or another machine learning-based analysis technique, the website may be classified as a specific type such as a shopping mall, a blog, a portal site, a community, or a corporate website. At the same time, UI elements and functional elements used in the website may be organized and may be used as templates for subsequent websites or applications to be automatically generated.

In step S240, cloud-based source code generation may be performed. Based on the structured data obtained in step S230, front-end and back-end code of a target website or application may be automatically generated. In one embodiment, predefined code templates may be used for the automatic generation of front-end and back-end code, and customized code may be generated depending on a selected framework and language.

In step S250, a process of automatically generating an API and a database (DB) schema may optionally be performed. Depending on a specific website type, a DB structure may be designed, and an API may be automatically generated accordingly. For example, in the case of a shopping mall website, a DB schema including tables related to products, orders, and payments may be automatically generated, and a REST API or GraphQL API may be configured based on the DB schema.

In step S260, a process of deploying the generated source code and API to a cloud or a serverless environment may be performed. Through this, the automatically generated website and application can run in an online environment without the need to directly manage a separate server infrastructure.

In step S270, software may be deployed so that it can run in a multi-OS environment. The present disclosure may support applications that are executable in various environments, including hybrid and native applications, as well as automatic website generation.

In steps S281 through S283, processes of deploying the automatically generated website and application to specific platforms may be performed. Step S281 may include web deployment, step S282 may include Android application deployment, and step S283 may include iOS application deployment. Through these deployment processes, the method and system of the present disclosure may be used not only for simple automatic website generation, but also for generating applications that can run on various operating systems or platforms.

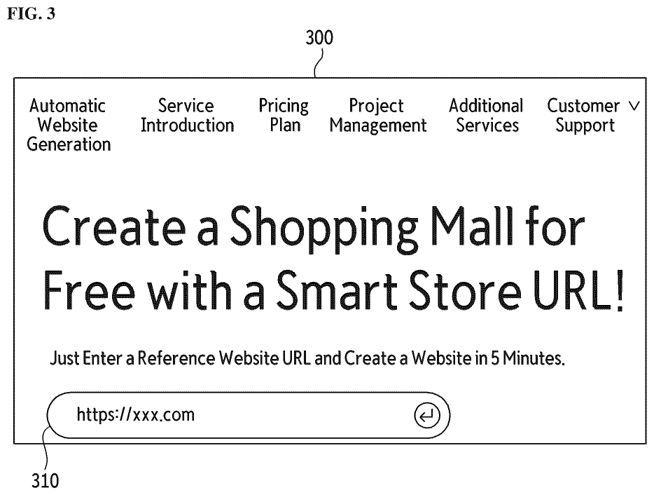

FIG. 3 is a diagram for explaining a method for acquiring identification information of a reference website according to an embodiment.

Information (300) provided to a user for acquiring identification information of a reference website may include a screen for guiding the user to register or input the reference website. The screen may show how to enter identification information of a website, supported website types, or a description of an automatic website generation process. Through this, the user may input a specific website to initiate the process of analyzing the structure and data of the website. According to one embodiment, identification information of a website may include the URL of the website.

A screen (310) for allowing the user to input identification information may include an input field through which the user may directly input or select the URL of a specific website. The input URL may be automatically analyzed, and navigation and data collection using a headless browser may be initiated. According to one embodiment, in order to allow the user to quickly register a website, an auto-suggestion function for frequently used websites or a default input example may be provided.

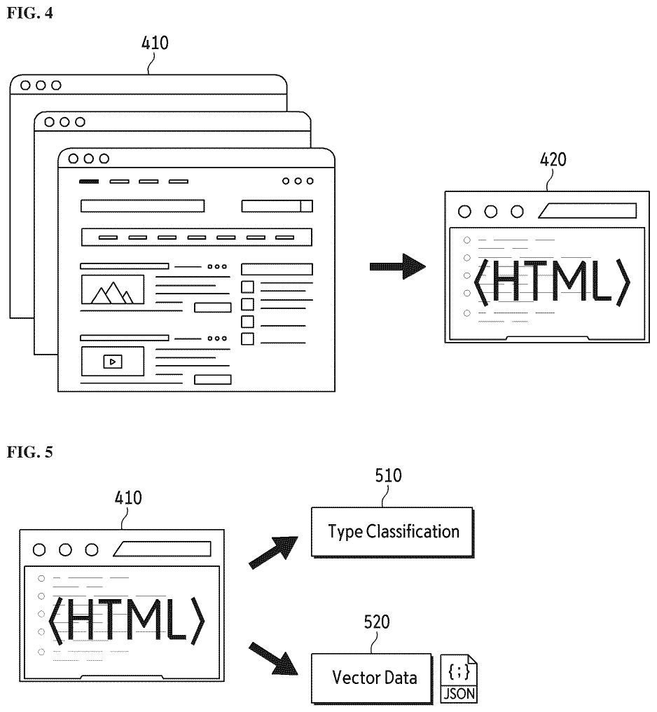

FIG. 4 is a diagram for explaining a method for acquiring data defining the structure or design of reference and linked websites according to an embodiment.

Reference and linked websites (410) may include not only a reference website input by a user but also related websites accessible through links on the reference website. For example, subpages within the reference website or related pages linked to external domains may be included in the reference and linked websites (410), thereby enabling more accurate website analysis.

Data (420) defining the structure or design of a website may include HTML, CSS, JavaScript, UI elements, and metadata retrievable from the reference and linked websites (410). For example, the data (420) may include the Document Object Model (DOM) structure, style information, and dynamic interaction elements of the reference and linked websites (410), and may be used for determining the type of the reference website or for automatically generating a new website based on the reference website.

According to one embodiment, the process of acquiring data from a website may be automated using a headless browser. The headless browser enables loading of HTML and dynamic data without rendering the website in an actual browser environment, and thereby enables analysis of the structure and operation of the website.

In addition, by using the headless browser, linked websites may also be analyzed by automatically exploring clickable links, without requiring direct user navigation. For example, the headless browser may analyze internal links, button click events, and dynamic content loading mechanisms of the reference website to enable more comprehensive data collection.

According to one embodiment, the headless browser may encompass tools such as Puppeteer, Selenium, and Playwright. These tools may perform a role of effectively analyzing the overall structure of a website and automatically collecting data.

In this manner, the website analysis process according to an embodiment of the present disclosure may be designed not to merely acquire static HTML data but to perform more precise analysis of data including dynamic website structures and linked websites.

FIG. 5 is a diagram for explaining how to perform website type determination and vector data acquisition according to an embodiment.

An AI reconstruction engine may acquire type classification information (510) and vector data (520) based on the data (420) collected from the reference and linked websites (410). According to one embodiment, the AI reconstruction engine may encompass a specialized large language model (SLLM) for analyzing the structure and functions of the reference website and an engine for generating front-end code (610) and back-end code (620) later.

The type classification information (510) may refer to a result obtained by analyzing structural characteristics, UI elements, and functional elements of the reference website and classifying the reference website as a specific type. For example, the type classification information (510) may include various website types such as a shopping mall, blog, portal site, and corporate website.

According to one embodiment, specific rules may be applied to identify the type of the reference website. For example,
In one example, when the screen of the reference website includes shopping cart and payment buttons or the data of the reference website includes @type: “Product”, the reference website may be classified as a shopping mall.
In one example, when the screen of the reference website includes author information, a publication date, or a comment function, or includes a <meta property=“og:type”content=“article”>tag or @type: “NewsArticle”, the reference website may be classified as a news or media site.
In one example, when the reference website includes price information, location information, and map integration functions, or includes <div class=“property-listing”>, <div class=“real-estate-listing”>tags, or @type: “RealEstateListing”, the reference website may be classified as a real estate site.
In one example, when elements such as <textarea class=“post-content”>, <button class=“like-btn”>, and <button class=“follow-btn”>exist or the URL path of the reference website includes/profile/, /user/, /members/, or /posts/, the reference website may be classified as an SNS platform.

In this manner, each website may be automatically classified as a specific type by analyzing its structure and functions.

The vector data (520) may refer to structured data generated by processing information extracted from the reference website, and may be converted into formats such as JSON, XML, or domain-specific language (DSL). The vector data (520) may include the DOM structure, style attributes, and dynamic interaction elements of the reference website, and may be used in a subsequent process of automatic website generation.

The type classification information (510) and the vector data (520) may be generated using a pre-trained and fine-tuned SLLM. The SLLM may analyze button layouts, page flows, and API integration methods of websites through training on specific website types, and may then propose optimized front-end and back-end structures when generating a new website, and provide efficient code and data structures during automatic website generation.

For example, an SLLM trained on shopping mall-type websites may analyze the layout of product detail pages, payment processes, and product recommendation methods, thereby supporting more precise generation of a new shopping mall website.

In this manner, information may be extracted from an existing website, and by using the extracted information, more precise type determination and data structuring may be performed in the process of generating a new website.

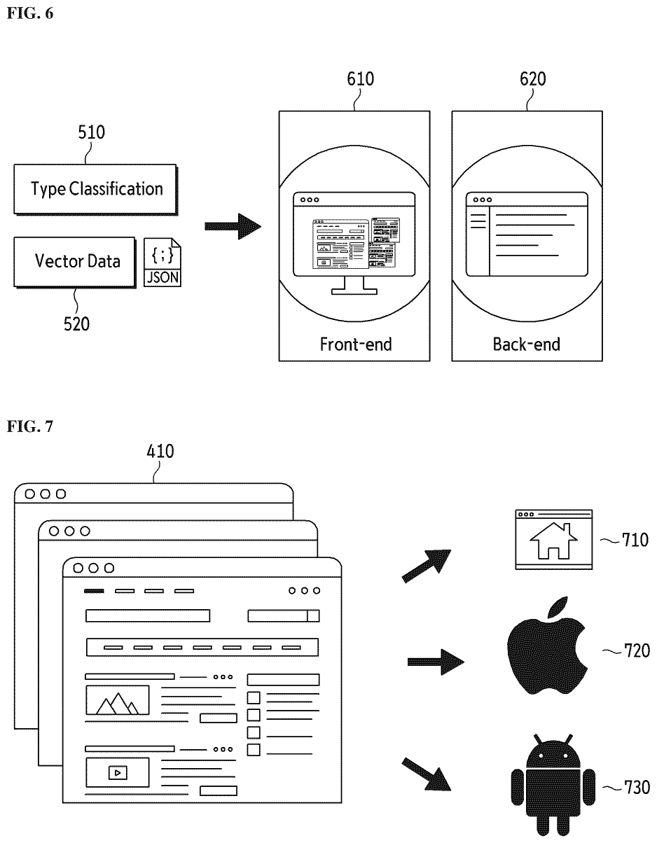

FIG. 6 is a diagram for explaining a process of generating front-end and back-end code according to an embodiment.

According to one embodiment, an AI reconstruction engine, a cloud-based source code generator, or an SLLM may receive the type classification information (510) and the vector data (520) as input and automatically generate the front-end code (610) and the back-end code (620). The type classification information (510) may refer to information for determining which category the reference website belongs to among types such as shopping mall, blog, portal site, and corporate website. The vector data (520) may refer to structured data that includes the UI elements, functional elements, a DOM structure, and style attributes of the reference website.

The front-end code (610), which refers to code responsible for the UI and screen elements of the reference website, may be implemented using technologies such as HTML, CSS, and JavaScript. The AI reconstruction engine or the SLLM may automatically define the layout, color scheme, and UI components (e.g., buttons, input fields, modals) of the reference website by analyzing the vector data (520), thereby allowing for automatic configuration of website screens. For example, in the case of a website classified as a shopping mall type, a UI including a product list, a shopping cart, and payment buttons may be automatically configured. The front-end code (610) may be automatically generated based on a framework such as React, Vue.js, or Angular, and the user may modify or change the UI or the style of the reference website as needed.

The back-end code (620), which refers to code executed on the server side, may include functions such as database integration, API provision, and authentication and authorization management. The AI reconstruction engine or the SLLM may analyze the data flow of the reference website based on the type classification information (510) and the vector data (520) and may automatically generate suitable back-end logic. For example, in the case of a website classified as a shopping mall type, an API for retrieving a product list, a shopping cart function, and a payment integration function may be automatically generated, and in the case of a website classified as an SNS type, functions such as user profile management, post creation, and comment features may be included in the back-end code (620). The back-end code (620) may be generated based on a back-end framework such as Node.js, Django, Spring Boot, or FastAPI, and the AI reconstruction engine or the SLLM may automatically perform database modeling and API endpoint configuration.

The front-end code (610) and the back-end code (620), automatically generated by the AI reconstruction engine, the cloud-based source code generator, or the SLLM, may each be individually modified based on the user's selection and may be deployed to a cloud environment or an on-premise environment as needed. In addition, options for adding user-customized functions while maintaining consistency between the front-end code (610) and the back-end code (620) may be provided. For example, when the user desires to apply a specific security policy or further adjust UI elements, the AI reconstruction engine or the cloud-based source code generator may provide guidance and support the user in directly editing the front-end code (610) and the back-end code (620).

As described above, according to this embodiment of the present disclosure, the front-end code (610) and the back-end code (620) may be automatically generated based on the type classification information (510) and the vector data (520), thereby significantly simplifying the process of website development. By utilizing the AI reconstruction engine, the cloud-based source code generator, or the SLLM, the structure and functions of the reference website may be quickly analyzed, and optimized code may be automatically generated to provide an efficient result while minimizing developer intervention.

Meanwhile, in another embodiment, generation of the front-end code (610) may be performed by the AI reconstruction engine, and generation of the back-end code (620) and APIs may be performed by the cloud-based source code generator.

FIG. 7 is a diagram for explaining a process of generating a website, an iOS application, and an Android application according to an embodiment.

FIG. 7 illustrates how to generate a website (710), an iOS application (720), and an Android application (730) according to an embodiment.

According to one embodiment, data acquired from the reference and linked websites (410) may be analyzed by the AI reconstruction engine or the SLLM, and based on the analyzed data, the website (710), the iOS application (720), and the Android application (730) may be automatically generated.

The website (710) may be generated using web technologies such as HTML, CSS, and JavaScript, and may be optimized to run on PC and mobile browsers. The iOS application (720) may be generated as a native or hybrid application in compliance with Apple's development guidelines and may be configured for distribution on the Application Store. The Android application (730) may be generated as a native or hybrid application executable in the Android environment and may be developed to be distributed on the Google Play Store.

As described above, according to this embodiment of the present disclosure, the website (710), the iOS application (720), and the Android application (730) may be automatically generated based on data from a single reference website (410), thereby efficiently achieving multi-platform support.

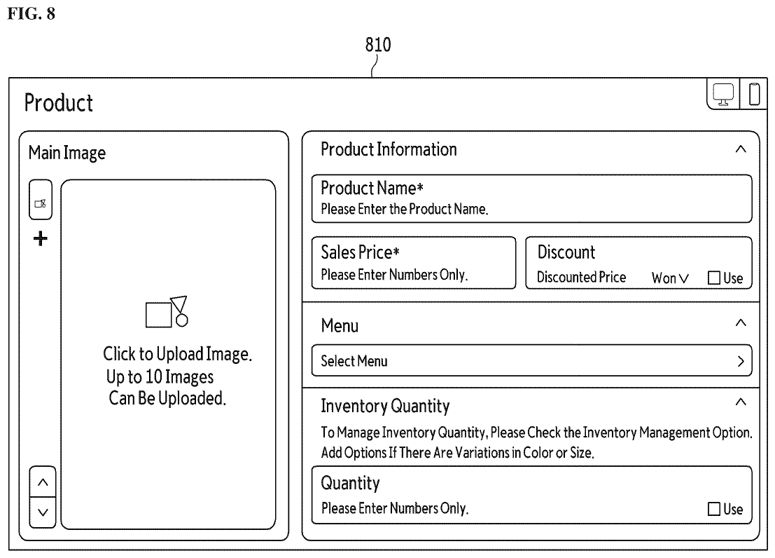

FIG. 8 is a diagram for explaining a process of registering a product after website generation according to an embodiment.

According to one embodiment, a target website generated by the AI reconstruction engine may initially be in a blank state with no products registered, and when the user inputs product information through a product registration screen (810), the product information may be reflected in the target website. In the product registration screen (810), the user may input a product name, sales price, discount rate, inventory quantity, and the like, and the registered product may be automatically updated in the product list and detail page of the target website.

In addition, the user may input and apply company information, homepage information, and the like to the target website, thereby configuring basic information and branding elements of the target website. The user may also perform various functions such as product management, order management, menu registration and editing, shipping fee policy setting, payment policy setting, payment gateway (PG) application, member registration function setting, promotion setting, push message sending, and application launch-related settings. These functions may be provided through a management interface, and the settings entered by the user may be immediately reflected in the operation of the target website.

As described above, according to this embodiment of the present disclosure, the target website automatically generated using the AI reconstruction engine may be configured to support product and operational settings based on the user's input, and as a result, the user may construct a customized e-commerce environment.

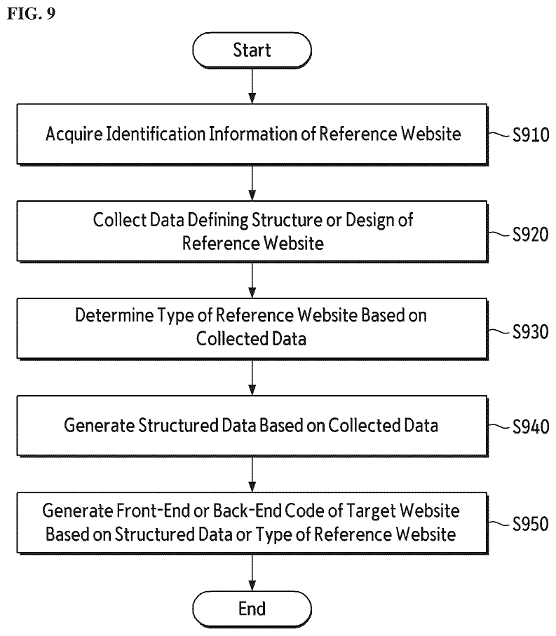

FIG. 9 is a flowchart illustrating the overall steps of an automatic website generation method according to an embodiment.

Step S910 is a step of acquiring identification information of a reference website. In this step, the URL or other identification information of the reference website input by the user may be collected, and data of the reference website may be explored based on the collected information. This step serves as the starting point of an automatic website generation process and may serve to secure basic data for performing data collection and analysis in subsequent steps.

Step S920 is a step of collecting data defining the structure or design of the reference website. In this step, the reference website and websites linked to the reference website may be explored using a headless browser, and in this process, the structural and design information of the entire reference website, including dynamically loaded data, may be acquired. The collected data may include information such as HTML, CSS, JavaScript, UI elements, metadata, and screen transition flows.

Step S930 is a step of determining the type of the reference website based on the collected data. In this step, the collected data may be analyzed to determine which specific type (e.g., shopping mall, blog, portal site, corporate website, etc.) the reference website belongs. Website type determination may be performed using a pre-trained and fine-tuned LLM, and automatic type determination may be enabled by analyzing the layout, UI elements, and functional attributes of the reference website. Additionally, a hierarchical information structure of the reference website may be generated, and the type of the reference website may be determined based on the hierarchical information structure, and a method for capturing screens of the reference website and linked websites and analyzing the captured screens may also be applied for determining the type of the reference website. Furthermore, when the reference website includes characteristics of multiple types, major functions and structural characteristics may be analyzed to determine a single type, and the training data may be continuously updated to improve the accuracy of type determination.

Step S940 is a step of generating structured data based on the collected data. In this step, unstructured website data may be converted into structured data in a format such as JSON or XML to allow use in a subsequent automatic website generation process. The structured data may include the DOM structure, style attributes, and dynamic interaction elements of the reference website, and may be used in a subsequent step of generating the code of a target website.

Step S950 is a step of generating front-end or back-end code of a target website based on the structured data or the type of the reference website. In this step, an AI reconstruction engine may automatically generate front-end code (e.g., HTML, CSS, JavaScript, etc.) and back-end code (e.g., API, database schema, etc.), thereby enabling generation of the target website without separate development work. After generation of the target website, UI adjustment, function addition, and payment system integration may be performed on the target website through additional settings.

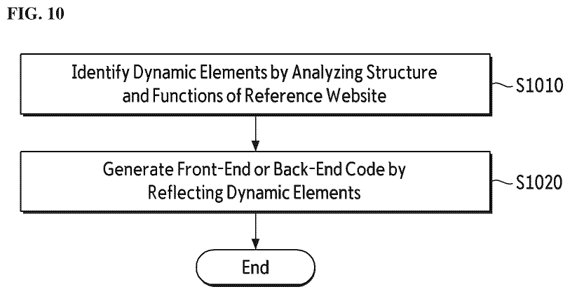

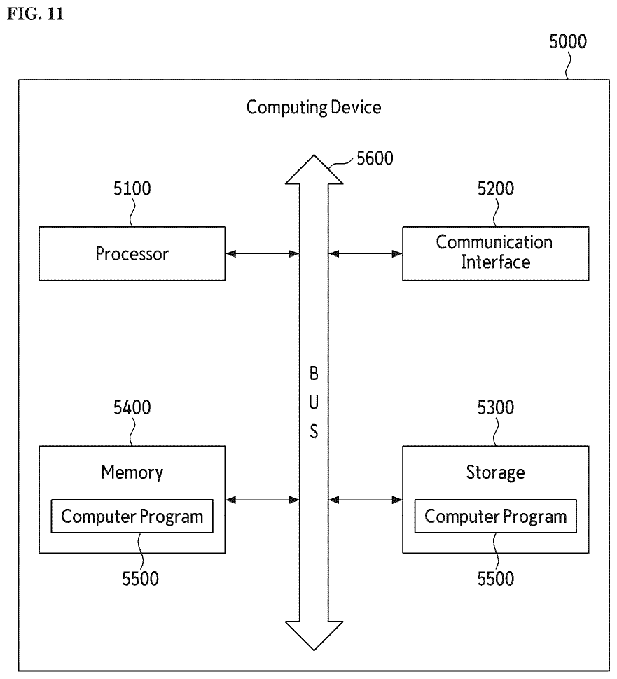

FIG. 10 is a flowchart illustrating additional steps of the automatic website generation method according to an embodiment.

Step S1010 is a step of identifying dynamic elements by analyzing the structure and functions of the reference website. In this step, dynamic elements may be extracted by analyzing the HTML, CSS, JavaScript, UI elements, and API integration method of the reference website. Dynamic elements may include elements that change in response to user input, external data integration, or screen transition flows. For example, functions for transmitting and receiving data via APIs, UI elements dynamically updated through AJAX requests, user login and authentication functions, real-time chat interfaces, and autocomplete search functions may be identified as dynamic elements. This step may include API integration, and various API call patterns used in the reference website, such as REST API, GraphQL API, and WebSocket-based communication, may be analyzed, thereby extracting dynamic elements.

Step S1020 is a step of generating front-end or back-end code of the target website by reflecting the identified dynamic elements. In this step, based on the dynamic elements identified from the reference website, appropriate code may be automatically generated so that the target website may perform the same operations. For example, when the reference website retrieves data through a specific API, code may be generated for the target website to perform the same API request. In addition, when the target website processes user input, corresponding front-end UI elements and back-end data processing logic may be automatically configured. In this step, both front-end code and back-end code may be generated, and may be optimized for the environment of the target website while maintaining the functionality of the dynamic elements.

According to this embodiment, the processes of analyzing dynamic elements and generating code may be automatically performed using an AI reconstruction engine based on an LLM. The LLM may propose an optimized code structure for the target website by learning the dynamic elements of the reference website. Moreover, the LLM may reflect differences from the reference website to improve specific functions or transform them into more efficient code structures.

FIG. 11 is a block diagram illustrating the hardware configuration of a computing device associated with automatic website generation according to an embodiment of the present disclosure.

Referring to FIG. 11, a computing device (5000) may include at least one processor (5100), a bus (5600), a communication interface (5200), a memory (5400) that loads a computer program executed by the processor (5100), and a storage (5300) that stores the computer program (5500). However, it will be understood by those skilled in the art that the computing device (5000) may include additional general-purpose components other than those illustrated in FIG. 11. That is, the computing device (5000) may include various other components in addition to those shown in FIG. 11. Additionally, in some cases, the computing device (5000) may be configured with some of the components in FIG. 11 omitted. Hereinafter, each component of the computing device (5000) will be described. Throughout this disclosure, the terms “computing device (5000)” and “computing system” may be used interchangeably.

The processor (5100) may control overall operations of the components of the computing device (5000). The processor (5100) may include at least one of a Central Processing Unit (CPU), a Microprocessor Unit (MPU), a Microcontroller Unit (MCU), a Graphic Processing Unit (GPU), or any type of processor well known in the technical field of the present disclosure. The processor (5100) may also perform computations for at least one application or program for executing the operations/methods according to embodiments of the present disclosure. The computing device (5000) may include one or more processors.

Next, the memory (5400) may store various types of data, commands, and/or information. The memory (5400) may load the computer program (5500) from the storage (5300) in order to execute the operations/methods according to embodiments of the present disclosure. The memory (5400) may be implemented as a volatile memory, such as Random Access Memory (RAM), although the present disclosure is not limited thereto.

Next, the bus (5600) may provide communication functionality among the components of the computing device (5000). The bus (5600) may be implemented in various forms such as an address bus, data bus, and control bus.

Next, the communication interface (5200) may support wired or wireless internet communication for the computing device (5000). The communication interface (5200) may also support various other communication methods in addition to internet communication. To this end, the communication interface (5200) may include communication modules well known in the technical field of the present disclosure.

Next, the storage (5300) may store one or more computer programs (5500) in a non-transitory manner. The storage (5300) may include non-volatile memory such as Read-Only Memory (ROM), Erasable Programmable ROM (EPROM), Electrically Erasable Programmable ROM (EEPROM), flash memory, a hard disk, a removable disk, or any computer-readable recording medium well known in the relevant technical field.

Next, the computer program (5500), when loaded into the memory (5400), may include one or more instructions that cause the processor (5100) to perform the operations/methods according to various embodiments of the present disclosure. That is, the processor (5100) may execute the loaded instructions to perform the operations/methods according to various embodiments of the present disclosure.

For example, the computer program (5500) may include instructions to perform operations of acquiring identification information of a reference website; collecting data accessible through the identification information, the data including data defining a structure or design of the reference website and websites linked to the reference website; determining a type of the reference website based on the collected data; generating structured data based on the collected data; and generating front-end or back-end code of a target website based on at least one of the structured data or the type of the reference website.

The automatic website generation method and system according to the present disclosure may provide the following effects.

First, the structure and functions of a reference website may be automatically analyzed to determine the type of the reference website, and a target website may be generated based on the determined type. Conventionally, a website developer has to individually analyze HTML, CSS, JavaScript, and API structures and manually write code. However, according to the present disclosure, a website may be automatically generated using an AI reconstruction engine. As a result, time and cost required for website development may be reduced.

Second, data of the reference website and linked websites may be collected, and structured data may be generated based on the collected data. Conventionally, website data is collected in an unstructured format and manually analyzed. However, according to the present disclosure, the HTML, CSS, JavaScript, UI elements, metadata, and the like of a website may be automatically analyzed using a headless browser and an LLM, and may be converted into structured data.

Third, front-end code and back-end code may be automatically generated by reflecting dynamic elements. Unlike a conventional static website copying method, according to the present disclosure, API integration, AJAX requests, and user interactions of the reference website may be analyzed and reflected in generating the front-end and back-end code of the target website. As a result, a fully functional website capable of real service operation may be automatically constructed beyond simple copying of webpages.

Fourth, websites and applications executable in a multi-OS environment may be generated so as to be utilized in various operating environments. According to the present disclosure, the target website may be converted and distributed not only as a website (HTML/CSS/JavaScript) but also as an Android or iOS application. This allows the user to provide services optimized for both web and mobile environments from a single source, minimizing limitations due to operating systems and devices.

Fifth, user-customized website generation and management functions may be provided. According to the present disclosure, the generated target website may initially be in a blank state (e.g., without any registered products), and may be dynamically configured as the user performs operations such as product registration, menu editing, payment policy setting, and promotion setting. Through this, the user may easily configure and manage the target website according to their business model and operating method.

Sixth, the accuracy of website type determination and code generation may be improved through continuous learning. According to the present disclosure, the AI reconstruction engine may learn major functions and structural characteristics of websites and update criteria for type determination through website data learning. As a result, even when new types of websites emerge, optimized websites may continue to be automatically generated through adaptive learning.

In conclusion, the automatic website generation method and system according to the present disclosure may reduce the time and cost required for website creation and maintenance by automating the website development process. Furthermore, unlike a conventional static copying method, the present disclosure supports the generation of front-end code and back-end code that reflects dynamic elements, thereby enabling the automatic construction of websites suitable for actual service operation. The present disclosure is not limited to specific types of websites and may be applicable across various industries and business models.

1. An automatic website generation method executed by a computing system, comprising:
acquiring identification information of a reference website;
collecting data accessible through the identification information of the reference website, the collected data including data defining a structure or design of the reference website and websites linked to the reference website;
determining a type of the reference website based on the collected data;
generating structured data based on the collected data; and
generating front-end or back-end code of a target website based on at least one of the structured data or the type of the reference website.

2. The automatic website generation method of claim 1, further comprising:
identifying dynamic elements of the reference website by analyzing the structure and functions of the reference website, the dynamic elements including an application programming interface (API); and
generating the front-end or back-end code of the target website by reflecting the identified dynamic elements.

3. The automatic website generation method of claim 1,
wherein the collecting of the data accessible through the identification information of the reference website comprises: exploring the reference website and the linked websites using a headless browser; and collecting data defining the structure or design of the reference website based on data dynamically loaded during the exploration.

4. The automatic website generation method of claim 1, wherein
the determining of the type of the reference website or the generating of the structured data based on the collected data is performed using a large language model (LLM) pre-trained and fine-tuned on HTML, CSS, JavaScript, user interface (UI) elements, metadata, or screen transition flows of websites, and
the LLM automatically determines a type of a specific website by analyzing a layout, UI elements, and functional attributes of the specific website, or converts unstructured website data into a structured format.

5. The automatic website generation method of claim 1,
wherein the determining of the type of the reference website comprises:
generating a hierarchical information structure of the reference website using the collected data, the hierarchical information structure including tree-structured data; and
determining the type of the reference website using the hierarchical information structure.

6. The automatic website generation method of claim 1,
wherein the determining of the type of the reference website comprises:
capturing screens of the reference website and at least one website linked to the reference website; and
determining the type of the reference website using images of the captured screens.

7. The automatic website generation method of claim 1,
wherein the determining of the type of the reference website comprises:
when the reference website includes characteristics of multiple types, determining a single type from among the multiple types by analyzing major functions and structural characteristics of the reference website; and
updating criteria for type determination by performing website data learning to improve the accuracy of the determining of the type of the reference website.

8. An automatic website generation method executed by a computing system, comprising:
acquiring identification information of a reference website;
collecting data accessible through the identification information of the reference website, the collected data including data defining a structure or design of the reference website and websites linked to the reference website;
determining a type of the reference website based on the collected data;
generating structured data based on the collected data; and
generating front-end or back-end code of a target website based on at least one of the structured data or the type of the reference website.

9. The automatic website generation system of claim 8,
wherein the at least one processor is further configured to perform operations of:
identifying dynamic elements of the reference website by analyzing the structure and functions of the reference website, the dynamic elements including an application programming interface (API); and
generating the front-end or back-end code of the target website by reflecting the identified dynamic elements.

10. The automatic website generation system of claim 8,
wherein the operation of collecting the data accessible through the identification information of the reference website comprises:
exploring the reference website and the linked websites using a headless browser; and
collecting data defining the structure or design of the reference website based on data dynamically loaded during the exploration.

11. The automatic website generation system of claim 8, wherein
the operation of determining the type of the reference website or generating the structured data based on the collected data is,
performed using a large language model (LLM) pre-trained and fine-tuned on HTML, CSS, JavaScript, user interface (UI) elements, metadata, or screen transition flows of websites, and
the LLM automatically determines a type of a specific website by analyzing a layout, UI elements, and functional attributes of the specific website, or converts unstructured website data into a structured format.

12. The automatic website generation system of claim 8,
wherein the operation of determining the type of the reference website comprises:
generating a hierarchical information structure of the reference website using the collected data, the hierarchical information structure including tree-structured data; and
determining the type of the reference website using the hierarchical information structure.

13. The automatic website generation system of claim 8,
wherein the operation of determining the type of the reference website comprises:
capturing screens of the reference website and at least one website linked to the reference website; and
determining the type of the reference website using images of the captured screens.

14. The automatic website generation system of claim 8,
wherein the operation of determining the type of the reference website comprises:
when the reference website includes characteristics of multiple types, determining a single type from among the multiple types by analyzing major functions and structural characteristics of the reference website; and
updating criteria for type determination by performing website data learning to improve the accuracy of the operation of determining the type of the reference website.
